(19) United States
(12) Patent Application Publication
(10) Pub. No.: US 2011/0213758 A1
(43) Pub. Date: Sep. 1, 2011

(54) METHOD, APPARATUS, AND SYSTEM FOR SUBSCRIPTION AND NOTIFICATION

(76) Inventors: Junliang CAO, Xi'an (CN); Lan WANG, Xi'an (CN); Feng SU, Xi'an (CN); Junjun JIA, Xi'an (CN)

(21) Appl. No.: 13/104,518

(22) Filed: May 10, 2011

Related U.S. Application Data
(63) Continuation of application No. PCT/CN2009/074781, filed on Nov. 4, 2009.

(30) Foreign Application Priority Data
Nov. 12, 2008 (CN) 200810217431.8

(51) Int. Cl. G06F 17/30; G06F 7/00

(52) U.S. Cl. 707/691; 707/802; 707/769; 707/E17.014; 707/E17.044

(57) ABSTRACT

A method, an apparatus, and a system for subscription and notification are disclosed. The method includes the following steps: a Home Subscriber Server Front-End (HSS FE) receives a first subscription request which is sent by an Application Server (AS) and carries data content that the AS requests to subscribe to; the HSS FE sends a second subscription request to a convergent database, where the first subscription request and the second subscription request have a subscription relation; the HSS FE receives a notification sent by the convergent database according to the second subscription request; and the HSS FE sends data content carried in the notification to the AS according to the subscription relation. The present invention enables the AS to obtain the subscribed data from the HSS FE.

### CROSS-REFERENCE TO RELATED APPLICATIONS

This application is a continuation of International Application No PCT/CN2009/074781, filed on Nov. 4, 2009, which claims priority to Chinese Patent Application No. 200810217431.8, filed on Nov. 12, 2008, both of which are hereby incorporated by reference in their entireties.

### FIELD OF THE INVENTION

The present invention relates to communication technologies, and in particular, to a method, an apparatus, and a system for subscription and notification.

### BACKGROUND OF THE INVENTION

A Home Subscriber Server (HSS) is a main data register that stores subscriber and service related data in an Internet Protocol Multimedia Subsystem (IMS). The data stored mainly includes the subscriber identity, registration information, access parameters, and trigger information. An Application Server (AS) is an entity that provides value-added multimedia services in an IMS. The reference point between the AS and the HSS is the Sh reference point. The AS operates the data in the HSS through the Sh reference point. The AS can also subscribe to the data in the HSS. When certain data of a specified subscriber in the HSS is updated, the AS will receive a notification.

A convergent database is a common data storage apparatus as a result of the development in network evolution. The convergent database provides a storage platform to store the data of different networks and the data of different network elements in a centralized manner.

After the convergent database is adopted, subscriber data in a network will be stored in the central database and therefore, network elements in the network that previously store subscriber data require service and data separation so that the subscriber data is stored in the convergent database and the network elements previously storing subscriber data will only process their service logics.

After data and service separation on the HSS, the HSS only processes service logics and in this case, is referred to as a Home Subscriber Server Front-End (HSS FE). Because subscription to data is still realized through the Sh reference point between the HSS FE and the AS while the data previously stored in the HSS is now stored in the convergent database, the AS will fail to obtain the subscribed data from the HSS FE.

### SUMMARY OF THE INVENTION

Embodiments of the invention provide a method, an apparatus, and a system for subscription and notification, so that an AS can obtain the subscribed data from an HSS FE after data and services are separated on the HSS.

A method for subscription and notification includes:

receiving, by an HSS FE, a first subscription request which is sent by an AS and carries data content that the AS requests to subscribe to;

sending, by the HSS FE, a second subscription request to a convergent database, where the first subscription request and the second subscription request have a subscription relation;

receiving, by the HSS FE, a notification sent by the convergent database according to the second subscription request; and

sending, by the HSS FE, data content carried in the notification to the AS according to the subscription relation.

An HSS FE includes:

a first receiving unit, configured to receive a first subscription request which is sent by an AS and carries data content that the AS requests to subscribe to;

a subscription request generating unit, configured to generate a second subscription request to be sent to a convergent database according to the received first subscription request or data content that the AS is allowed to subscribe to;

a subscription relation generating unit, configured to generate a subscription relation between the first subscription request and the second subscription request;

a first sending unit, configured to send the second subscription request to the convergent database;

a second receiving unit, configured to receive a notification sent by the convergent database; and

a second sending unit, configured to send data content carried in the received notification to the AS according to the subscription relation.

A system for subscription and notification includes an AS, a convergent database, and:

an HSS FE, configured to receive a first subscription request sent by the AS and send a second subscription request to the convergent database, where the first subscription request and the second subscription request have a subscription relation; and

further configured to receive a notification sent by the convergent database and send data content carried in the notification to the AS according to the subscription relation.

In the embodiments of the invention, a subscription of the AS to the HSS FE is converted to a subscription of the HSS FE to the convergent database, so that the AS can subscribe to the content in the convergent database indirectly. When the content subscribed to by the AS in the convergent database is changed, the HSS FE will notify the AS of the changed data content, so that the AS obtains the subscribed data from the HSS FE.

### BRIEF DESCRIPTION OF THE DRAWINGS

FIG. 1 illustrates relations between an AS, an HSS FE, and a convergent database in the prior art;

FIG. 2 is a flowchart of a method for subscription and notification in an embodiment of the invention;

FIG. 3 is a flowchart of the method for subscription and notification in another embodiment of the invention;

FIG. 4 is a flowchart of the method for subscription and notification in another embodiment of the invention;

FIG. 5 is a flowchart of the method for subscription and notification in another embodiment of the invention;

FIG. 6 is a flowchart of the method for subscription and notification in another embodiment of the invention;

FIG. 7 is a block diagram of an HSS FE provided in an embodiment of the invention; and

FIG. 8 is a block diagram of a system for subscription and notification in an embedment of the invention.

### DETAILED DESCRIPTION OF THE EMBODIMENTS

FIG. 1 illustrates the relations between an AS, an HSS FE, and a convergent database where the HSS FE processes service logics and the convergent database stores subscriber data.

The embodiments of the invention provide a method, an apparatus, and a system for subscription and notification. An HSS FE receives a first subscription request from an AS and sends a second subscription request to the convergent database where the data content subscribed through the second subscription request includes the data content subscribed through the first subscription request, so that the AS can subscribe to the content in the convergent database indirectly; when the data subscribed through the second subscription request is changed in the convergent database, the convergent database sends a notification request to notify the HSS FE of the data change; the HSS FE then notifies the AS of the data content carried in the notification request, so that the AS obtains the subscribed data from the HSS FE.

To better explain the technical solution provided by the present invention, the embodiments of the present invention will be described in detail with reference to the accompanying drawings. The embodiments here are exemplary embodiments for the purpose of explaining the present invention but are not intended to limit the present invention.

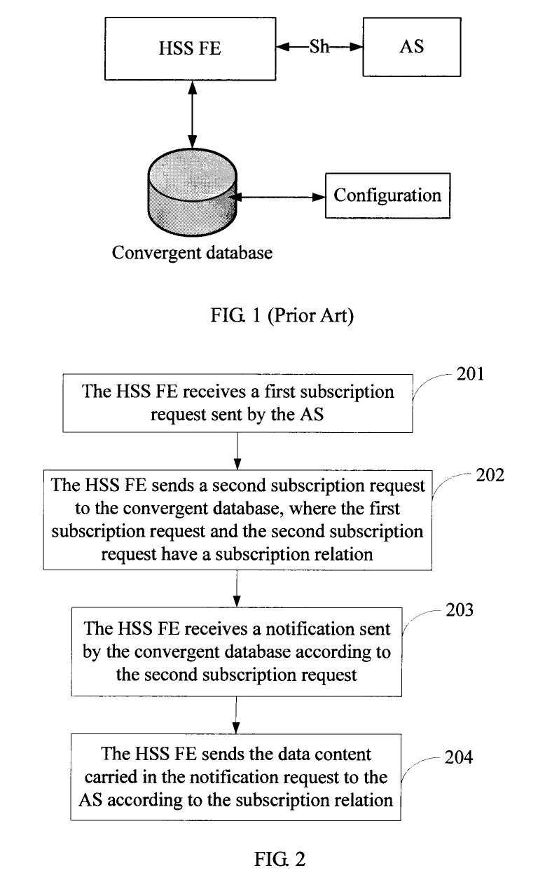

FIG. 2 gives a flowchart of a method for subscription and notification in an embodiment of the invention. The method includes the following steps:

Step 201: An HSS FE receives a first subscription request which is sent by an AS and carries the data content that the AS requests to subscribe to.

Step 202: The HSS FE sends a second subscription request to a convergent database, where the second subscription request has a subscription relation with the first subscription request.

Step 203: The HSS FE receives a notification sent by the convergent database according to the second subscription request.

Step 204: The HSS FE sends the data content carried in the notification to the AS according to the subscription relation.

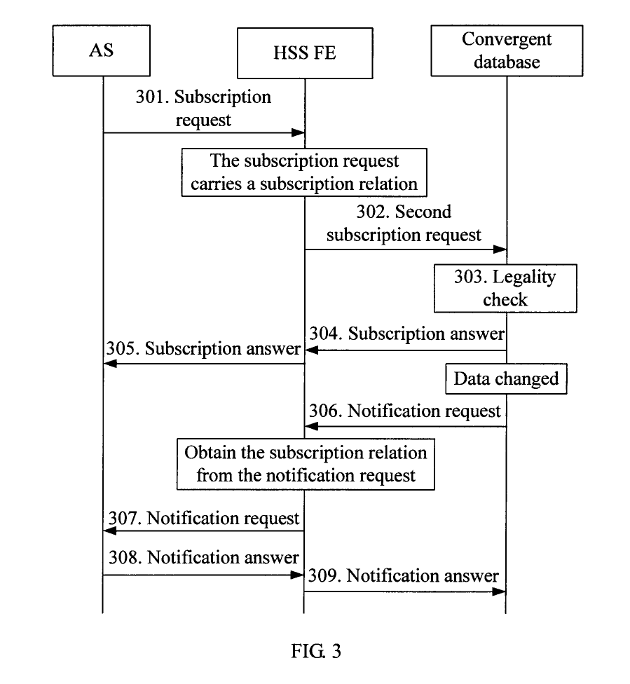

FIG. 3 shows a flowchart of the method according to another embodiment of the invention. In this embodiment, the HSS FE converts subscriptions of the AS to subscriptions to the convergent database. That is, the HSS FE converts a first subscription request sent by the AS to a second subscription request sent to the convergent database and includes a subscription relation between the two subscriptions in the second subscription request through supplementary notification data, where the subscription relation carries at least the address of the AS and may further carry the subscription content of the AS and the subscription ID and the validity period of the second subscription request; when the subscribed data is changed in the convergent database, the convergent database sends a notification request to the HSS FE, where the notification request carries at least the address of the HSS FE and may further carry the changed data content and the subscription ID of the second subscription request, and where the notification request carries the subscription relation through supplementary notification data; and the HSS FE converts the received notification request to a notification request sent to the AS according to the notification request and the subscription relation. Specifically, the method includes the following steps:

Step 301: The AS initiates a first subscription request to the HSS FE through a Subscribe Notification Request (SNR) command, where the subscription content may include the name of the AS initiating the subscription, subscriber identity, subscribed data, and subscription validity period.

Step 302: After receiving the first subscription request of the AS, the HSS FE checks the legality of the subscription request and if the subscription is illegal, returns check failure; if the subscription is legal, the HSS FE converts the first subscription request to a second subscription request to be sent to the convergent database and generates a subscription relation between the first subscription request and the second subscription request, where the subscription relation includes at least the address of the AS and may further include the subscription content of the AS and the subscription ID and validity period of the second subscription request. The data content subscribed through the second subscription request includes the data content subscribed through the first subscription request. The trigger condition of the subscription is change of the subscribed data content. The notification receiver is the HSS FE. The second subscription request carries supplementary notification data which includes the subscription relation.

Step 303: The convergent database receives the second subscription request and checks the legality of the subscription request. If the subscription is illegal, the convergent database returns check failure and otherwise, step 304 continues.

Step 304: The convergent database searches stored subscription information and checks whether the same subscription already exists. That is, the convergent database checks for the existence of a previous subscription which has the same ID and the same HSS FE address as the second subscription request. If such a subscription is found, the convergent database updates subscription validity period of subscription information of the previous subscription and returns a subscription answer; otherwise, the convergent database stores the subscription information and subscription relation of the second subscription request and returns a subscription answer.

Step 305: The HSS FE receives the subscription answer of the convergent database and returns a Subscribe Notification Answer (SNA) to the AS.

Step 306: When the data in the convergent database is changed, the convergent database checks the subscription information constructed according to the second subscription request and decides whether the subscription will be triggered. When the subscription data related to the second subscription request in the convergent database is changed, the convergent database constructs a notification request according to the subscription information. The notification request carries supplementary notification data which is the subscription relation. The content of the notification request may include the address of the HSS FE, the changed data content, and the subscription ID of the second subscription request.

Step 307: The HSS FE receives the notification request of the convergent database and converts the notification content in the notification request into a format suitable for transmission over the Sh interface between the AS and the HSS FE. The HSS GE determines the address of the AS according to the subscription relation carried in the notification request, extracts the changed data content, constructs a Push Notification Request (PNR), and sends the PNR to the related AS.

Step 308: The AS receives the PNR of the HSS FE and returns a Push Notification Answer (PNA) to the HSS FE.

Step 309: The HSS FE returns a notification answer to the convergent database according to the PNA of the AS.

Step 304 where the convergent database checks for the existence of a previous subscription which has the same ID and the same HSS FE address as the second subscription request includes when the same AS subscribes to the same content repetitively, the HSS FE can update the validity period and other information of the subscription.

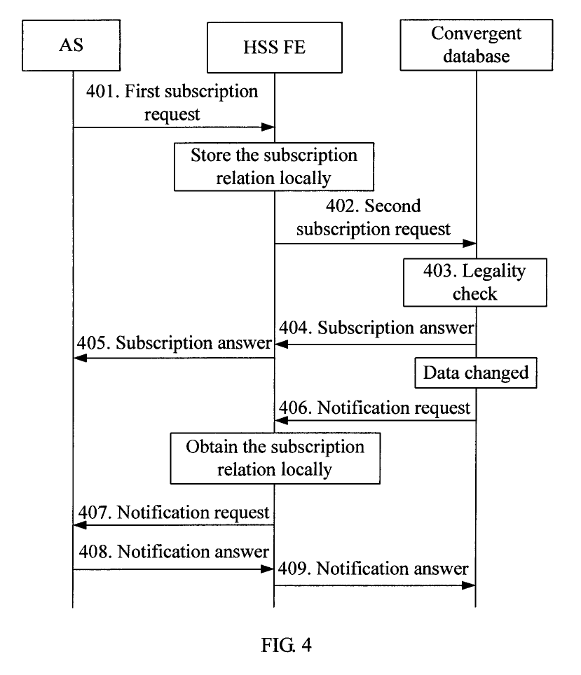

FIG. 4 is a procedure of the method for subscription and notification in another embodiment of the invention. The procedure includes the following steps:

Step 401: The AS initiates a first subscription request to the HSS FE through an SNR command, where the subscription content may include the name of the AS initiating the subscription, subscriber identity, subscribed data, and subscription validity period.

Step 402: After receiving the first subscription request of the AS, the HSS FE checks the legality of the subscription request and if the subscription is illegal, returns check failure; if the subscription is legal, the HSS FE converts the first subscription request to a second subscription request to be sent to the convergent database and generates a subscription relation between the first subscription request and the second subscription request, where the subscription relation includes at least the address of the AS and subscription ID of the second subscription request and may further include the subscription content and the subscription validity period of the AS. The data content subscribed through the second subscription request is the data content in the convergent database that matches the data content subscribed through the first subscription request. The trigger condition of the subscription is change of the subscribed data content. The notification receiver is the HSS FE. The subscription relation is stored in the HSS FE.

Step 403: The convergent database receives the second subscription request and checks the legality of the second subscription request. If the subscription is illegal, the convergent database returns check failure and otherwise, step 404 continues.

Step 404: The convergent database searches stored subscription information and checks whether the same subscription already exists. That is, the convergent database checks for the existence of a previous subscription which has the same ID and the same HSS FE address as the second subscription request. If such a subscription is found, the convergent database updates the subscription validity period of the subscription information of the previous subscription and returns a subscription answer; otherwise, the convergent database stores the subscription information of the second subscription request and returns a subscription answer.

Step 405: The HSS FE receives the subscription answer of the convergent database and returns an SNA to the AS.

Step 406: When the data in the convergent database is changed, the convergent database checks the subscription information constructed according to the second subscription request and decides whether the subscription will be triggered. When the subscription data related to the second subscription request in the convergent database is changed, the convergent database constructs a notification request according to the subscription information. The notification request carries the address of the HSS FE, the changed data content, and the subscription ID of the second subscription request.

Step 407: The HSS FE receives the notification request of the convergent database and converts the notification content in the notification request into a format suitable for transmission over the Sh interface between the AS and the HSS FE. The HSS FE searches the related subscription relation locally according to the subscription ID of the second subscription request carried in the notification request, extracts the address of the AS, constructs a PNR, and sends the PNR to the related AS.

Step 408: The AS receives the PNR of the HSS FE and returns a PNA to the HSS FE.

Step 409: The HSS FE returns a notification answer to the convergent database according to the PNA of the AS.

In the embodiment of the invention, the HSS FE converts each subscription of the AS into a subscription addressed to the convergent database. The HSS FE stores the subscription relation between the two subscriptions locally. When the subscription in the convergent database is triggered, the convergent database sends a notification request to the HSS FE. The HSS FE obtains the related subscription relation locally according to the subscription ID of the second subscription request carried in the notification request, extracts the address of the AS, and sends the data content in the notification request of the convergent database to the AS, so that the AS obtains the subscribed data from the HSS FE.

Note that the subscription relation may alternatively be stored in the convergent database in step 402. Specifically, the second subscription request of the HSS FE carries the subscription relation and the convergent database stores the subscription relation; or the HSS FE sends the subscription relation to the convergent database separately. Accordingly, in step 407, when the HSS FE receives the notification request of the convergent database, the HSS FE searches the related subscription relation in the convergent database according to the subscription ID of the second subscription request, obtains the address of the AS, and forwards the data content carried in the notification request to the AS.

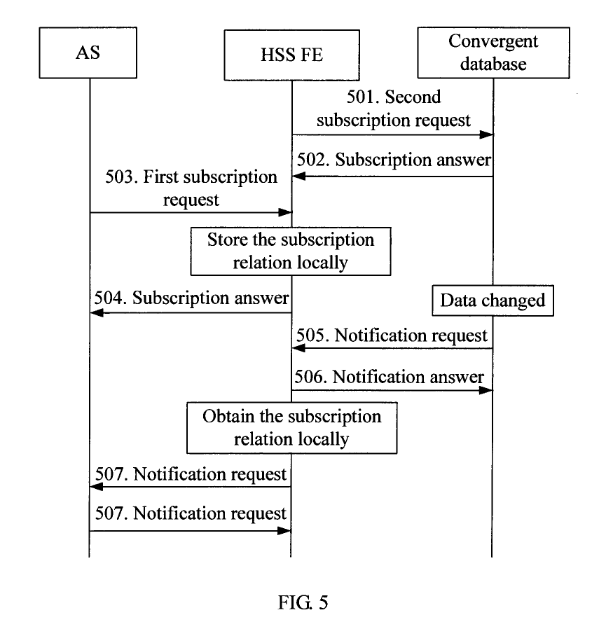

FIG. 5 gives a procedure of the method for subscription and notification in another embodiment of the invention. The method includes the following steps:

Step 501: Upon system startup, the HSS FE initiates a second subscription request to the convergent database, where the subscription content of the subscription request is a superset of the content allowing the AS to subscribe to, the trigger condition of the subscription is change of the subscribed data, and the notification receiver is the HSS FE.

Step 502: The convergent database receives the second subscription request and checks the legality of the subscription. If the subscription is illegal, the check fails; otherwise, the convergent database stores the subscription information and returns a subscription answer to the HSS FE. The subscription information may include the address of the HSS FE, the subscription content of the second subscription request, and the validity period of the subscription.

Step 503: The AS initiates a first subscription request to the HSS FE through an SNR command, where the subscription content of the subscription request includes the name of the AS initiating the subscription, subscriber identity, subscribed data, and subscription validity period.

Step 504: The HSS FE receives the first subscription request of the AS and checks the legality of the subscription request. If the subscription is illegal, the HSS FE returns check failure; otherwise, the HSS FE stores a subscription relation between the first subscription relation and the second subscription relation locally and returns an SNA to the AS. The subscription relation may include the address of the AS and the subscription content and subscription validity period of the first subscription request.

Step 505: When the data in the convergent database is changed, the convergent database checks the subscription information constructed according to the second subscription request and decides whether the subscription will be triggered. When the subscription data related to the second subscription request in the convergent database is changed, the convergent database constructs a notification request according to the subscription information and sends the notification request to the HSS FE. The notification request may carry the address of the HSS FE and the changed data content.

Step 506: The HSS FE receives the notification request of the convergent database and returns a notification answer to the convergent database.

Step 507: The HSS FE searches the related subscription relation locally according to the changed data content carried in the received notification request, extracts the address of the AS from the subscription relation, constructs a PNR according to the changed content in the received notification request, and sends the PNR to the AS.

Step 508: The AS receives the PNR sent by the HSS FE and returns a PNA to the HSS FE.

In the embodiment of the invention, the HSS FE initiates a subscription to the convergent database upon startup, where the subscription content is a superset of the content allowing the AS to subscribe to. When the AS initiates a subscription request to the HSS FE, the HSS FE need not initiate another subscription request to the convergent database but stores the subscription relation between the two subscriptions locally, specifically, the address of the AS, the subscription content of the AS, and the validity period of the subscription. When, in the convergent database, the data related to the subscription content of the HSS FE is changed, the convergent database sends a notification request to the HSS FE. The HSS FE searches the related subscription relation locally according to the changed data content carried in the received notification request, extracts the address of the AS from the subscription relation, and sends the changed data content carried in the received notification request of the convergent database to the AS, so that the AS obtains the subscribed data from the HSS FE.

Note that the subscription relation may alternatively be stored in the convergent database. That is, in step 504, the HSS FE may store the generated subscription relation in the convergent database, where the subscription relation may include the address of the AS and the subscription content of the first subscription request. In step 507, accordingly, when the HSS FE receives the notification request of the convergent database, the HSS FE searches the related subscription relation in the convergent database according to the changed data content carried in the notification request, extracts the address of the AS, and sends the changed data content carried in the notification request of the convergent database to the AS.

In step 504, after receiving the first subscription request of the AS, the HSS FE may query the subscription relation stored locally or in the convergent database and decide whether a subscription of the same AS to the same content already exists. If such a subscription is found, the HSS FE updates the subscription validity period of the subscription relation; otherwise, the HSS FE generates a subscription relation of the first subscription request.

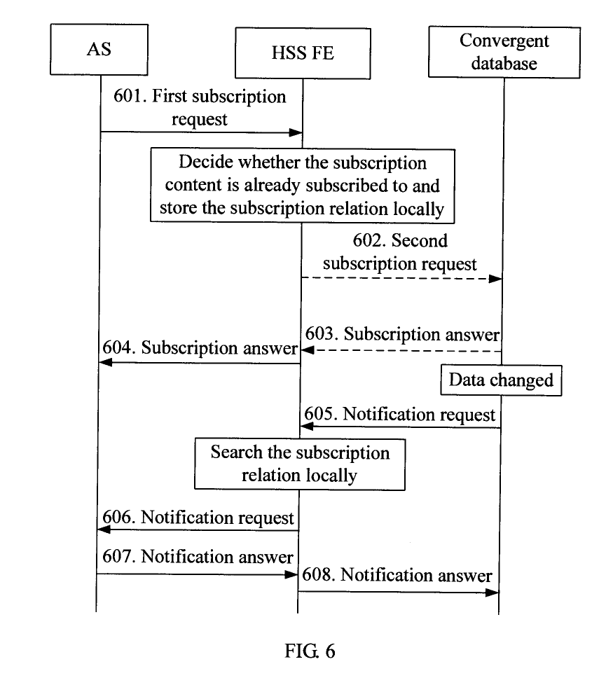

FIG. 6 gives a procedure of the method for subscription and notification in another embodiment of the invention. The method includes the following steps:

Step 601: The AS initiates a first subscription request to the HSS FE through an SNR command, where the subscription content includes information, such as the name of the AS initiating the subscription, subscriber identity, subscribed data, and subscription validity period.

Step 602: After receiving the first subscription request of the AS, the HSS FE checks the legality of the subscription request. If the subscription is illegal, the HSS FE returns check failure; otherwise, the HSS FE decides whether a previous subscription intended for the subscription content of the first subscription request exists. Specifically, the HSS FE searches the subscription relations stored in the convergent database or the HSS FE and checks for the existence of a subscription relation whose subscription content is the same as the subscription content of the first subscription request.

If such a subscription is found, the HSS FE extracts the subscription ID in the subscription relation related to the previous subscription and the address of the AS and the subscription content in the first subscription request and combines them into a subscription relation related to the first subscription request. Then the HSS FE returns an SNA to the AS and step 605 continues.

If no such subscription is found, the HSS FE converts the first subscription request into a second subscription request to be sent to the convergent database and generates a subscription relation between the first subscription request and the second subscription request. The subscription relation includes at least the address of the AS, the subscription ID of the second subscription request, and the subscription content of the AS, and may further include the subscription validity period. The subscription content of the second subscription request is the data in the convergent database matching the subscription content of the first subscription request. The trigger condition of the subscription is change of the subscribed data. The notification receiver is the HSS FE. The subscription relation is stored in the HSS FE.

Step 603: The convergent database receives the second subscription request and checks the legality of the second subscription request. If the subscription is illegal, the convergent database returns check failure and otherwise, stores the subscription information of the second subscription request and returns a subscription answer.

Step 604: The HSS FE receives the subscription answer of the convergent database and returns an SNA to the AS.

Step 605: When the data in the convergent database is changed, the convergent database checks the stored subscription information and decides whether the subscription will be triggered. When the subscribed data in the convergent database is changed, the convergent database constructs a notification request according to the subscription information. The notification request may carry the address of the HSS FE, the changed data content, and the subscription ID of the second subscription request.

Step 606: The HSS FE receives the notification request of the convergent database and converts the notification content in the notification request into a format suitable for transmission over the Sh interface between the AS and the HSS FE. The HSS FE searches the related subscription relation locally according to the subscription ID of the second subscription request carried in the notification request, extracts the address of the AS, constructs a PNR, and sends the PNR to the related AS.

Step 607: The AS receives the PNR of the HSS FE and returns a PNA to the HSS FE.

Step 608: The HSS FE returns a related notification answer to the convergent database according to the PNA of the AS.

Note that the subscription relation may alternatively be stored in the convergent database in step 602. Specifically, the second subscription request of the HSS FE carries the subscription relation and the convergent database stores the subscription relation; or the HSS FE sends the subscription relation to the convergent database separately. Accordingly, in step 606, when the HSS FE receives the notification request of the convergent database, the HSS FE searches the related subscription relation in the convergent database according to the subscription ID carried in the notification request, obtains the address of the AS, and forwards the data content carried in the notification request to the AS, so that the AS obtains the subscribed data from the HSS FE.

Note in all embodiments of the present invention, a method for constructing the subscription ID of the second subscription request is: the HSS FE constructs the subscription ID of the second subscription request according to the address of the AS and the subscription content of the AS. When the HSS FE receives multiple subscriptions of the same AS to the same content, the subscription ID of the second subscription request converted from the subscriptions is the same. The above is only one exemplary method for constructing the subscription ID of the second subscription request and does not limit the implementation of the present invention.

According to the method for subscription and notification in the embodiments of the invention, the embodiments of the invention also provide an apparatus and a system for subscription and notification.

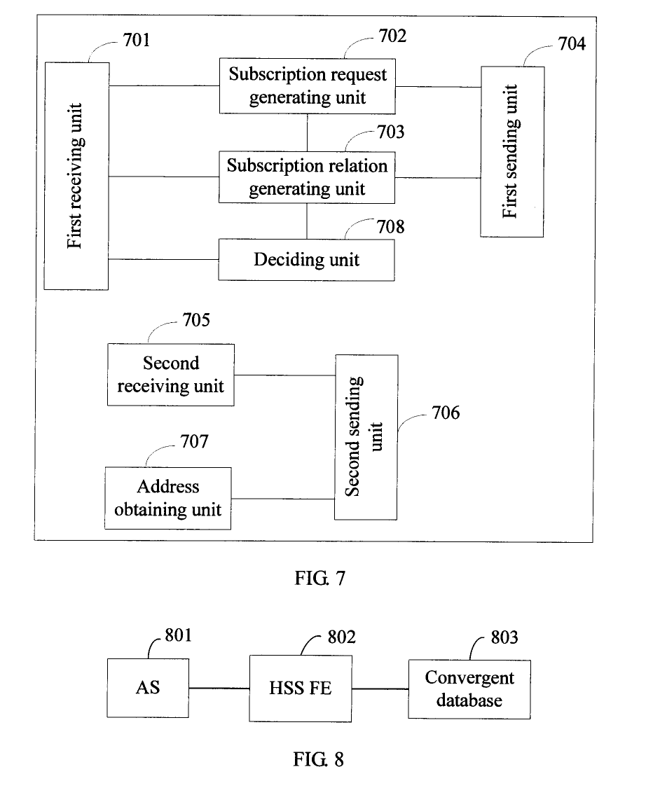

FIG. 7 is a block diagram of an HSS FE provided in an embodiment of the invention. The HSS FE includes a first receiving unit 701, a subscription request generating unit 702, a subscription relation generating unit 703, a first sending unit 704, a second receiving unit 705, and a second sending unit 706.

The first receiving unit 701 is configured to receive a first subscription request which is sent by an AS and carries the data content that the AS requests to subscribe to.

The subscription request generating unit 702 is configured to generate a second subscription request to be sent to the convergent database according to the received first subscription request or the data content that the AS is allowed to subscribe to.

The subscription relation generating unit 703 is configured to generate a subscription relation between the first subscription request and the second subscription request.

The first sending unit 704 is configured to send the second subscription request to the convergent database.

The second receiving unit 705 is configured to receive a notification sent by the convergent database.

The second sending unit 706 is configured to send the data content carried in the received notification to the AS according to the subscription relation.

The HSS FE further includes an address obtaining unit 707, configured to obtain the address of the AS according to the subscription relation and send the address of the AS to the second sending unit.

The HSS FE further includes a checking unit 708 configured to check the existence of a subscription with the same subscribed data content and the same AS address as the first subscription request after the HSS FE receives the first subscription request sent by the AS.

FIG. 8 illustrates a system for subscription and notification in an embodiment of the invention. The system includes an AS 801, a convergent database 803, and:

an HSS FE 802, configured to receive a first subscription request sent by the AS 801 and send a second subscription request to the convergent database 803, where the first subscription request and the second subscription request have a subscription relation.

The HSS FE 802 is further configured to receive a notification sent by the convergent database 803 and send the data content carried in the notification to the AS 801 according to the subscription relation.

The embodiments of the invention provide a method, an apparatus, and a system for subscription and notification, where a subscription of the AS to the HSS FE is converted to a subscription of the HSS FE to the convergent database, so that the AS can subscribe to the content in the convergent database indirectly. When the subscribed content of the AS in the convergent database is changed, the HSS FE will notify the AS of the changed data content, so that the AS obtains the subscribed data from the HSS FE.

Those skilled in the art understand that all or a part of the steps in the method provided by the foregoing embodiments of the invention can be implemented by hardware under the instruction of a program. The program can be stored in a computer readable storage medium. The storage medium here is a Read Only Memory (ROM), a Random Access Memory (RAM), a magnetic disc, or a Compact Disk-Read Only Memory (CD-ROM).

Although the present invention is described through some exemplary embodiments, the present invention is not limited to such embodiments. It is apparent that those skilled in the art can make various modifications and variations to the invention without departing from the spirit and scope of the present invention. The invention is intended to cover the modifications and variations provided that they fall within the scope of protection defined by the claims or their equivalents.

What is claimed is:

1. A method for subscription and notification, comprising:
receiving, by a Home Subscriber Server Front-End (HSS FE), a first subscription request which is sent by an Application Server (AS) and carries data content that the AS requests to subscribe to;
sending, by the HSS FE, a second subscription request to a convergent database, wherein the first subscription request and the second subscription request have a subscription relation;
receiving, by the HSS FE, a notification sent by the convergent database according to the second subscription request; and
sending, by the HSS FE, data content carried in the notification to the AS according to the subscription relation.

2. The method of claim 1, wherein: when the subscription relation is carried in the second subscription request, the notification sent by the convergent database according to the second subscription request carries the subscription relation which comprises at least an address of the AS; and
the step of sending the data content carried in the notification to the AS according to the subscription relation comprises:
by the HSS FE, obtaining the address of the AS from the subscription relation carried by the notification and sending the data content carried in the notification to the AS according to the address of the AS.

3. The method of claim 1, wherein: when the subscription relation is stored in the HSS FE, the notification sent by the convergent database according to the second subscription request carries a subscription ID of the second subscription request wherein the subscription relation comprises at least an address of the AS and the subscription ID of the second subscription request; and the step of sending the data content carried in the notification to the AS according to the subscription relation comprises:
by the HSS FE, searching a related subscription relation according to the subscription ID of the second subscription request carried in the notification and obtaining the address of the AS; and
sending the data content carried in the notification to the AS according to the address of the AS.

4. The method of claim 1, wherein: when the subscription relation is stored in the convergent database, the notification sent by the convergent database according to the second subscription request carries a subscription ID of the second subscription request wherein the subscription relation comprises at least an address of the AS and the subscription ID of the second subscription request; and the step of sending the data content carried in the notification to the AS according to the subscription relation comprises:
sending, by the HSS FE, a subscription relation query request to the convergent database, wherein the query request carries the subscription ID of the second subscription request;
by the HSS FE, receiving a subscription relation which is returned by the convergent database and comprises the subscription ID of the second subscription request; and
sending, by the HSS FE, the data content carried in the notification to the AS according to the address of the AS.

5. The method of claim 1, wherein: when the second subscription request carries a superset of data content that the AS is allowed to subscribe to, the subscription relation comprises at least an address of the AS and the data content that the AS requests to subscribe to; and the step of sending the data content carried in the notification to the AS according to the subscription relation comprises:
by the HSS FE, searching a related subscription relation according to the data content carried in the notification and obtaining the address of the AS; and
sending the data content carried in the notification to the AS according to the address of the AS.

6. The method of claim 1, wherein the second subscription request comprises the data content that the AS requests to subscribe to and which is carried in the first subscription request.

7. The method of claim 1, wherein the data content carried in the notification is the data content that the AS requests to subscribe to.

8. The method of claim 2, wherein: when the first subscription request carries a subscription validity period, the second subscription request carries the subscription validity period; the convergent database receives the second subscription request and checks the existence of a subscription with same subscribed data content and a same HSS FE address as the second subscription request; and if such a subscription exists, the convergent database updates the validity period of the subscription.

9. The method of claim 3, wherein: when the first subscription request carries a subscription validity period, the second subscription request carries the subscription validity period; the convergent database receives the second subscription request and checks the existence of a subscription with the same subscribed data content and the same HSS FE address as the second subscription request; and if such a subscription exists, the convergent database updates the validity period of the subscription.

10. The method of claim 4, wherein: when the first subscription request carries a subscription validity period, the second subscription request carries the subscription validity period; the convergent database receives the second subscription request and checks the existence of a subscription with the same subscribed data content and the same HSS FE address as the second subscription request; and if such a subscription exists, the convergent database updates the validity period of the subscription.

11. The method of claim 5, wherein when the first subscription request carries a subscription validity period, after the HSS FE receives the first subscription request sent by the AS, the method further comprises:
by the HSS FE, checking the existence of a subscription with the same subscribed data content and the same AS address as the first subscription request; and if such a subscription exists, updating the validity period of the subscription and otherwise, generating a subscription relation between the first subscription request and the second subscription request.

12. A Home Subscriber Server Front-End (HSS FE), comprising:
a first receiving unit, configured to receive a first subscription request which is sent by an Application Server (AS) and carries data content that the AS requests to subscribe to;
a subscription request generating unit, configured to generate a second subscription request to be sent to a convergent database according to the received first subscription request or data content that the AS is allowed to subscribe to;
a subscription relation generating unit, configured to generate a subscription relation between the first subscription request and the second subscription request;
a first sending unit, configured to send the second subscription request to the convergent database;
a second receiving unit, configured to receive a notification sent by the convergent database; and
a second sending unit, configured to send data content carried in the received notification to the AS according to the subscription relation.

13. The HSS FE of claim 12, further comprising:
an address obtaining unit, configured to obtain an address of the AS according to the subscription relation and send the address of the AS to the second sending unit.

14. The HSS FE of claim 12, further comprising a checking unit, configured to check the existence of a subscription with same subscribed data content to and a same AS address as the first subscription request after the HSS FE receives the first subscription request sent by the AS.

15. A system for subscription and notification, comprising an Application Server (AS), a convergent database, and:
a Home Subscriber Server Front-End (HSS FE), configured to receive a first subscription request sent by the AS and send a second subscription request to the convergent database, wherein the first subscription request and the second subscription request have a subscription relation; and
further configured to receive a notification sent by the convergent database and send data content carried in the notification to the AS according to the subscription relation.
